(19) United States
(12) Patent Application Publication
(10) Pub. No.: US 2007/0282624 A1
(43) Pub. Date: Dec. 6, 2007

(54) System and method for generating a value retention schedule

(76) Inventors: Michael J. Athey, Washington, IL (US); Wende D. Reeser, Washington, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/806,362

(22) Filed: May 31, 2007

Related U.S. Application Data
(60) Provisional application No. 60/809,384, filed on May 31, 2006.

(51) Int. Cl. G06Q 10/00; G06Q 30/00

(52) U.S. Cl. 705/1

(57) ABSTRACT

Systems and methods are disclosed that generate a value retention schedule for used equipment. In one embodiment, the method includes receiving equipment sales records, determining, based on the equipment sales records, a first median sales price of a first used equipment at a first equipment age for a set of time periods, determining a second median sales price of the first used equipment at a second equipment age for the set of time periods, determining a first ratio of the second median sales price to the first median sales price for each of the time periods in the set of time periods, determining a median ratio for the first ratio across the set of time periods, determining a value retention rate for the second equipment age based on the determined median ratio; and generating the value retention schedule based on the determined value retention rate.

### TECHNICAL FIELD

The present disclosure relates generally to data processing, and more particularly, to a system and method for generating a value retention schedule for used equipment using equipment transaction prices.

### BACKGROUND

Machines such as track-type tractors and wheel loaders, and other types of equipment, are used for a variety of tasks. Performing these tasks ultimately causes wear on the machines. Accordingly, the observed market value of a machine generally declines through time. For example, a new machine may be sold at an initial price of $200,000. After thirty six months of use, its market value may be 60% of the initial price, i.e., $120,000. After another twelve months of use, the machine's market value may be 40% of the initial price, i.e., $80,000.

A change in market value, however, may also be caused by factors unrelated to machine age, such as market conditions and technological advances. One way to understand market value of used equipment is by estimating and managing residual values. Residual value refers to the amount for which a business entity expects to be able to sell a piece of equipment at the end of its useful life. Systems and methods have been developed for estimating and managing used equipment residual values. For example, U.S. Pat. No. 6,502,080 (“the '080 patent”), issued to Eichorst et al. on Dec. 31, 2002, describes a method of predicting a net reserve for a vehicle leased by a lessee from a lessor in accordance with a lease. According to the '080 patent, the method may include: predicting a market value loss of the vehicle at a scheduled maturity date of the lease and obtaining the net reserve of the vehicle as a function of the predicted market value loss. The predicted market value loss is a function of: (i) a probability that the vehicle will be returned to the lessor after the lease, (ii) at least one predicted price at which the vehicle may sell after the lease, and (iii) a residual value of the vehicle that represents an aggregate of at least a projected price of the vehicle at the scheduled maturity date made prior to the lease and an enhancement amount.

While conventional systems may be effective to some extent at estimating and managing residual values of used equipment, they likely produce biased estimates of machine depreciation because observed changes in market value through time are composed of a mixture of many factors. For example, market prices for used equipment tend to change through time because of market conditions, i.e., the business cycle. Upturns in the economy may result in improving overall used equipment prices which will at least partially offset the loss in market value associated with the aging of equipment. Alternatively, economic slowdowns may produce a softening in used equipment prices which compound the impact of aging.

Similarly, used equipment prices may follow a regular (seasonal) pattern during a specified period a time (for example, a year) increasing during periods of high demand and decreasing during periods of low demand. Failure to account for this potential seasonality increases the likelihood of biased depreciation estimates as the sample of market transactions becomes less uniformity distributed across time.

Therefore, factors such as the state of economy and seasonal demand of certain industries may cause changes in used equipment sales and transaction prices that are unrelated to machine age, leading to outlier data. An outlier data point is a single observation “far away” from the rest of the data. In most samplings of data, some data points will be further away from their expected values than what is deemed reasonable. Such outlier data points can indicate faulty data, erroneous procedures, or areas where a certain theory might not be valid, although a small number of outliers are expected in normal distributions.

Further, conventional equipment transaction data samples may consist of an incomplete panel of individual machine transaction prices through time. Idiosyncrasies associated with individual pieces of equipment can also lead to price points significantly away from the central tendency associated with a particular category of machine. Conventional systems often use the mean transaction price to estimate market value for the “representative” used equipment, and therefore may be overly biased by outlier prices.

As a result, there is a need to correct for outlier data points when estimating and managing market value for used equipment. In other words, there is a need to estimate the change in market value for used equipment as the equipment ages, holding other factors constant. The present disclosure improves upon prior art systems by providing an accurate market value retention schedule for used equipment across various equipment ages.

### SUMMARY OF THE INVENTION

It is to be understood that both the foregoing general description and the following detailed description are exemplary and explanatory only and are not restrictive of the invention as claimed.

Systems and methods are disclosed that generate a value retention schedule for used equipment. In one embodiment, the method includes receiving equipment sales records, determining, based on the equipment sales records, a first median sales price of a first used equipment at a first equipment age for a set of time periods, determining a second median sales price of the first used equipment at a second equipment age for the set of time periods, determining a first ratio of the second median sales price to the first median sales price for each of the time periods in the set of time periods, determining a median ratio for the first ratio across the set of time periods, determining a value retention rate for the second equipment age based on the determined median ratio; and generating the value retention schedule based on the determined value retention rate.

### BRIEF DESCRIPTION OF THE DRAWINGS

The accompanying drawings, which are incorporated in and constitute a part of this specification, illustrate exemplary embodiments of the invention and together with the description, serve to explain the principles of the invention. In the drawings:

FIG. 1 is a block diagram of an exemplary used equipment management environment consistent with certain embodiments of the present disclosure;

FIG. 2 is a flow chart of exemplary steps to generate a value retention schedule/curve and a value comparison curve consistent with certain embodiments of the present disclosure;

FIG. 3A is an exemplary data table used in generating a value retention schedule consistent with certain embodiments of the present disclosure;

FIG. 3B is another exemplary data table used in generating a value retention schedule consistent with certain embodiments of the present disclosure;

FIG. 3C is another exemplary data table used in generating a value retention schedule consistent with certain embodiments of the present disclosure;

FIG. 3D is another exemplary data table used in generating a value retention schedule consistent with certain embodiments of the present disclosure;

FIG. 4 is an exemplary plot of used equipment value retention schedule consistent with certain embodiments of the present disclosure;

FIG. 5 shows two exemplary used equipment value retention curves consistent with certain embodiments of the present disclosure; and

FIG. 6 shows two exemplary value comparison curves consistent with certain embodiments of the present disclosure.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

In this disclosure, used equipment generally refers to any type of used machines, vehicles, or any other assets with a market value that declines over time. In the examples used in this disclosure, used equipment may be a used machine or a plurality of used machines. As such, used equipment, a used machine, and used machines are used interchangeably.

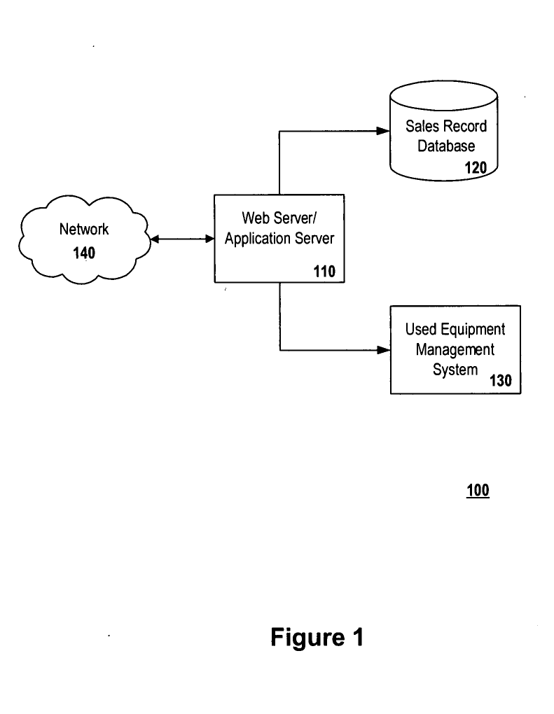

FIG. 1 is a block diagram illustrating an exemplary used equipment management environment 100. Used equipment management environment 100 may include a Web server/application server module 110, a sales record database 120, used equipment management system 130, and a network 140. Web server/application server module 110 interfaces with network 140. Web server/application server module 110 is also connected to sales record database 120 and used equipment management system 130. It is contemplated that used equipment management environment 100 may include some, all, or additional components illustrated in FIG. 1.

Web server/application server module 110 may include an interface device (e.g., graphical user interface) for a user to access sales record database 120, and/or used equipment management system 130. A user of used equipment management environment 100 may manage used equipment by requesting a value retention schedule through web server/application server module 110. A value retention schedule may be a data structure including data reflecting how well the market value of a piece of used equipment is maintained from the first use to various equipment ages. For example, a value retention schedule may show that a certain used machine retained 0.8 of its original value after one year of use, and 0.6 of its original value after two years of use.

Further, web server/application server module 110 may include additional software/hardware components, such as collaboration tools that permit users of used equipment management environment 100 to share data and information, to work together, bulletin boards to permit users to communicate with each other, and/or search engines to provide efficient access to specific entries in sales record database 120 or used equipment management system 130. One or more memory devices, such as web server/application server module 110 may also permit users of used equipment management environment 100 to submit records to be added to sales record database 120. As such, web server/application server module 110 may include one or more software and/or hardware components that enable a user or software process to manage information contained in used equipment management environment 100. Web server/application server module 110 may include any type of web server and/or application server software, such as Apache HTTP Server from the Apache Software Foundation.

Sales record database 120 may be a system including software executed by a processor that is configured to store sales records, charts, entries for changes made to the records, and other information used by users of used equipment management environment 100. A sales record may be any type of new and/or used equipment sales transaction record, such as a retail sales record, an auction sales record, and the like. Used equipment management environment 100 may include one or more sales record databases 120.

In one embodiment, sales record database 120 may include auction sales data records for used equipment, such as one or more used machines. An auction sales data record may include transactional information for a piece of equipment sold at auction, such as the make, model, model year, auction date, and auction price of the machine. Sales record database 120 may also include data used in calculating value retention schedules, such as value retention rates for used equipment, and charts of value retention schedules, etc. A value retention rate refers to the ratio of the market value of a piece of used equipment at a certain equipment age (e.g., a two year old machine) over the market value at an earlier (e.g., a one year old machine) equipment age. A value retention schedule measures how well the value of a piece of used equipment is maintained from the first use (i.e., zero year old) to a certain equipment age. A value retention schedule may be presented in any type of format, such as tables or charts, indicative of the true market value of used equipment for various equipment ages.

Used equipment management system 130 may be a computer system or software executed by a processor that is configured to provide access to sales records stored in sales records database 120. Used equipment management system 130 may receive requests from a user of used equipment management environment 100 through web server 110. Used equipment management system 130 may access data records stored in sales record database 120 to perform the calculations to generate value retention schedules as requested by the user. Used equipment management system 130 may also present a requested value retention schedule to the user through web server/application server module 110.

In one embodiment, used equipment management system 130 may generate a value retention schedule based on auction sales data records stored in sales record database 120. For example, a user may use web server/application server module 110 to request a value retention schedule for a specific make and model of a used machine. The user may also specify time periods from which web server/application server module 110 should base the value retention calculation. A time period may be any defined duration of time, such as a week, a month, a quarter, a year, etc. For example, the user may specify that the value retention schedule be generated based on sales/auction transactions completed in the first three quarters of 2005. Used equipment management system 130 may then access and process auction sales data records for the requested used machine stored in sales record database 120 and generate a value retention schedule based on sales data records with sales completion dates in the first three quarters of 2005. The value retention schedule generated by used equipment management system 130 may show the make and model of the used machine, the respective ages of the used machine (e.g., a one year old machine, a two year old machine, etc.), and the value retention rates at the different equipment ages.

Network 140 may be any type of communication network that transfers data, such as the Internet, a wireless or wireline local area network (LAN), or another type of network. Network 140 is intended in its broadest sense to encompass any communication system that uses any type of medium to transfer data.

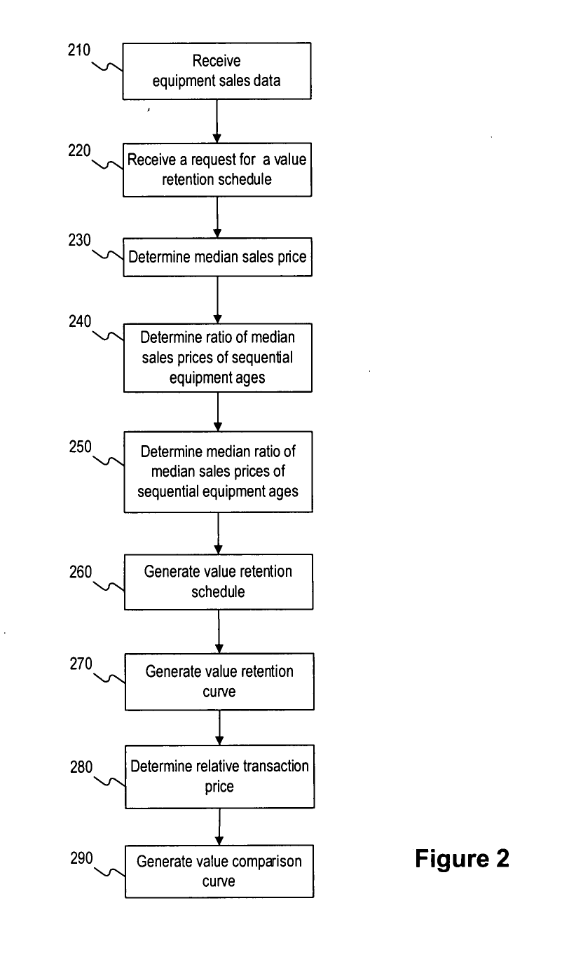

FIG. 2 is a flow chart of exemplary steps for generating a value retention schedule. First, used equipment management system 130 may receive equipment sales data (step 210). A sales data record may include sales transaction information for a piece of equipment sold, such as the make, model, model year, sales date, and sales price of the piece of equipment. For example, used equipment management system 130 may receive sales data for a first used machine. These sales data records may be sent to used equipment management system 130 from, for example, a dealership, an auction organizer, or any other service that may maintain used equipment sales data records. The sales data record may include data reflecting equipment age, sales price, date of sale, etc. Used equipment management system 130 may receive sales data records for different types of used equipment, and from various data sources. Further, used equipment management system 130 may store the sales data records in a database, such as sales record database 120.

Used equipment management system 130 may also receive a request to generate a value retention schedule (step 220). In one embodiment, a user may issue the request and specify the make and the model of the requested piece of used equipment. The user may also request a value retention schedule through web server/application server module 110. The request may also specify the equipment ages, and the one or more time periods for generating the requested value retention schedule. For example, a user may request a value retention schedule for a first machine for different equipment ages, such as zero, one, two, three, and four years. The user may further request that the value retention schedule be based on equipment sales completed in the first three quarters of a particular year, such as 2005.

In one embodiment, to reduce the effect of outliers in sales prices when determining the value retention schedule, used equipment management system 130 may use the median sales price to generate a requested value retention schedule instead of the mean sales price.

Based on the request for the value retention schedule, used equipment management system 130 may search sales record database 120 to retrieve sales data records related to the requested used equipment. For each requested equipment age, used equipment management system 130 may then determine the median sales price for the used equipment for every time period (step 230). Referring back to the above example, used equipment management system 130 may retrieve all relevant sales data records for the first used machine from sales records database 120, and then determine the median sales price by age for the first machine for each of the three quarters of 2005.

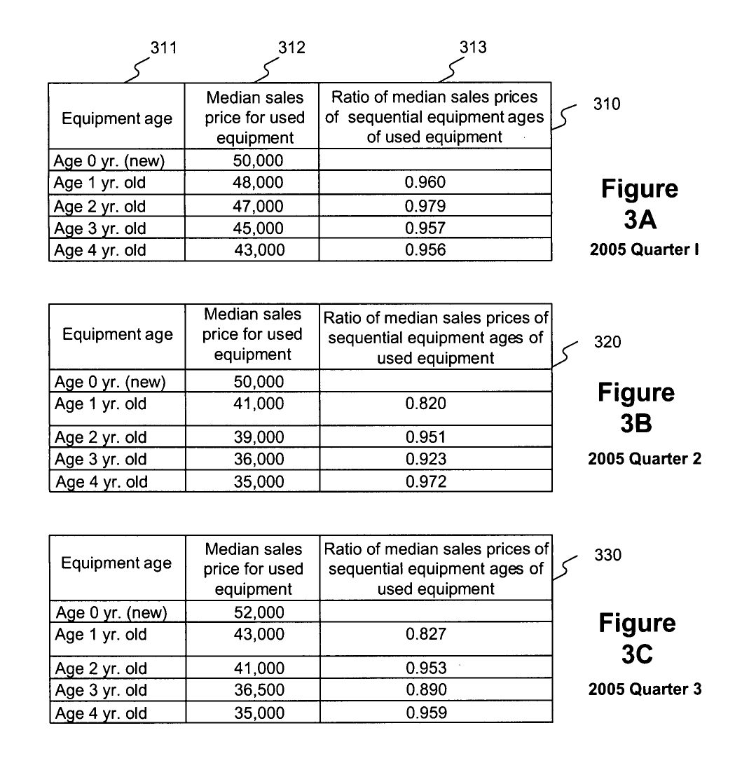

FIGS. 3A-3D show exemplary tables including data reflecting the results of calculating the value retention schedule based on the sales data for the first three quarters of 2005 for the above example. FIG. 3A shows a table 310 incorporating median sales data derived from individual machine transaction data associated with the first machine for the first quarter of 2005. Column 311 lists the requested equipment ages of the first machine. Column 312 includes the median sales price of the first machine at the requested equipment ages. Column 313 includes data reflecting the ratio of median sales prices of sequential equipment ages. Each row of table 310 includes data related to a specific equipment age of the first machine. For example, as shown in FIG. 3A, in the first quarter of 2005, the median sales price for the new machine is $50,000; the median sales price for the one year old machine is $48,000; the median sales price for the two year old machine is $47,000; the median sales price for the three year old machine is $45,000; and the median sales price for the four year old machine is $43,000. Similarly, used equipment management system 130 may determine the median prices for the first machine of different equipment ages for the second and third quarters of 2005, as shown in table 320 of FIG. 3B and table 330 of FIG. 3C respectively. If market prices in various sales channels (i.e., auction, retail, and the like) are sufficiently different from one another, producing the information in FIGS. 3A-3C for individual channels may be warranted prior to calculating the median ratio in FIG. 3D.

Used equipment management system 130 may also calculate the ratio of median sales prices (older machine relative to a machine that is one year younger) for each pair of sequential equipment ages (step 240). Used equipment management system 130 may then assign the ratio of median sales prices of sequential equipment ages to the older age in the equipment age sequence. Columns 313 of tables 310, 320, and 330 include data reflecting the ratio of median sales prices of sequential equipment ages. For example, referring back to FIG. 3A, in the first quarter of 2005, used equipment management system 130 may calculate the ratio of the median sales price for the one year old machine to the median sales prices for a brand new (a zero year old) machine as:

$48,000/$50,000=0.96

Used equipment management system 130 may then assign this ratio to the older age of the pair of sequential equipment ages (i.e., the older of the zero year old and the one year old first machine), which is the one year old equipment age. Similarly, used equipment management system 130 may calculate the ratio of the median sales price for the two year old machine to the median sales price for the one year old machine as:

$47,000/$48,000=0.979

Used equipment management system 130 may assign the ratio (0.979) to the two year old equipment age. The ratios of median sales prices for the first machine may be similarly calculated for the three year old and the four year old machines. Similarly, the ratios of median sales prices of sequential equipment ages may be calculated for the second and third quarters of 2005, as shown in FIGS. 3B and 3C, respectively.

For each machine age, used equipment management system 130 may then determine the median sales prices ratio of sequential equipment ages across multiple time periods (step 250). FIG. 3D shows an exemplary table 350 with a column 351 data reflecting the median sales price ratio across multiple time periods, and column 352 including data reflecting the value retention rates of the first machine at various equipment ages. Referring back to FIGS. 3A-3C, the one year old machine has an exemplary ratio of median sales prices of 0.96 in the first quarter of 2005, a ratio of 0.82 in the second quarter of 2005, and a ratio of 0.827 in the third quarter of 2005. Therefore, as shown in FIG. 3D, used equipment management system 130 may determine that the median sales price ratio across the three quarters of 2005, for the one year old machine, is 0.827.

As shown in FIG. 3D, the median sales price ratio for the two year old machine across the three quarters of 2005 is 0.953 (e.g., the median of 0.979, 0.951, and 0.953), the median sales price ratio for the three year old machine across the three quarters of 2005 is 0.923 (e.g., the median of 0.957, 0.923, and 0.890), and the median sales price ratio for the four year old machine across the three quarters of 2005 is 0.959 (e.g., the median of 0.956, 0.972, and 0.959).

Different factors may also affect the equipment sales price. For example, the exemplary first machine may have a different sales price in different time periods. As shown in FIGS. 3A-3C, the new (i.e., zero year old) machine has a median sales price of $50,000 in the first and second quarter of 2005. However, the new machine may have a median sales price of $52,000 in the third quarter of 2005. Additionally, in the first quarter of 2005, sales prices for the used machines of all equipment ages may be different than the second and the third quarters of 2005. These kinds of price fluctuations may be caused by changes in the supply of and demand for the equipment across years or within a year, and any other factors impacting market conditions. Used equipment management system 130 calculates value retention schedule using ratios of median sales prices of sequential equipment ages and the median sales price ratio across multiple time periods (e.g., across three quarters of 2005) to reduce the bias of outlier sales prices of used equipments caused by certain short term market conditions (e.g., urgent need of a large construction project, natural disaster, etc.) and non-market conditions, such as data limitations in the collected equipment transaction data.

As discussed earlier, used equipment management system 130 may use the median sales price of each time period to calculate value retention rates. In another embodiment, a user may vary the choice of the time periods (e.g., quarters versus years) to further reduce the impact of outlier transactions on the value retention rate calculation. Also, instead of the three quarters used in the first machine example discussed above, used equipment management system 130 may calculate the median sales price ratio (of sequential equipment ages) across multiple years to determine a value retention rate to reduce the impact of other cyclical market conditions across these years.

Used equipment management system 130 may generate the value retention schedule by calculating the fraction of the market value retained at each equipment age (step 260). The value retention rate at each equipment age may be determined by multiplying the median sales price ratio across given time periods for that equipment age by the value retention rate of the previous equipment age. In one example, used equipment management 130 may assume that a new machine maintains 100% of its value, and therefore may set the value retention rate at 1.0 for zero year old equipment age. For example, in FIG. 3D, used equipment management system 130 may set the value retention rate for the zero year old machine at 1.0. Used equipment management system 130 may then calculate the value retention rate of the one year old machine by multiplying the median sales price ratio across time periods for the one year old machine (i.e., 0.827) by the ratio of the zero year old (i.e., 1.0), such as,

0.827×1.0=0.827

Therefore, in this example, the one year old machine is assigned a value retention rate of 0.827. Similarly, used equipment management system 130 may calculate the value retention rate for the two year old machine by multiplying the median sales price ratio across time periods for the two year old machine (i.e., 0.953) by the value retention rate for the one year old machine (i.e., 0.827).

0.953×0.827=0.788

Thus, the two year old machine may be assigned a value retention rate of 0.788. As shown in FIG. 3D, the value retention rate of the three year old machine is therefore determined at 0.727 (i.e., 0.923×0.788); and the value retention rate of the four year old machine is determined at 0.698 (i.e., 0.959×0.727).

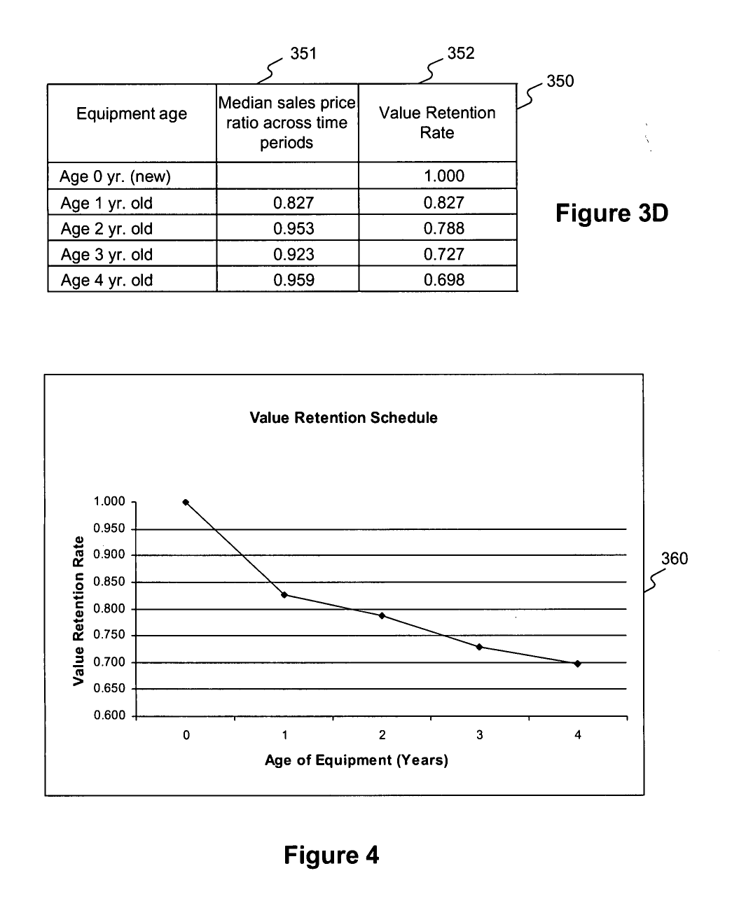

Used equipment management system 130 may then present a value retention schedule to the user. FIGS. 3D and 4 show an exemplary value retention schedule 350 that may be presented to a user. As shown in FIG. 3D, value retention schedule table 350 may present the value retention rates for various equipment ages across a certain time period. For example, schedule 350 shows an exemplary value retention schedule for the zero, one, two, three, and four year old first machines, based on the sales data of the first three quarters of 2005. The value retention schedule of 350 may be shown as a graph 360 with the value retention rates plotted against equipment age.

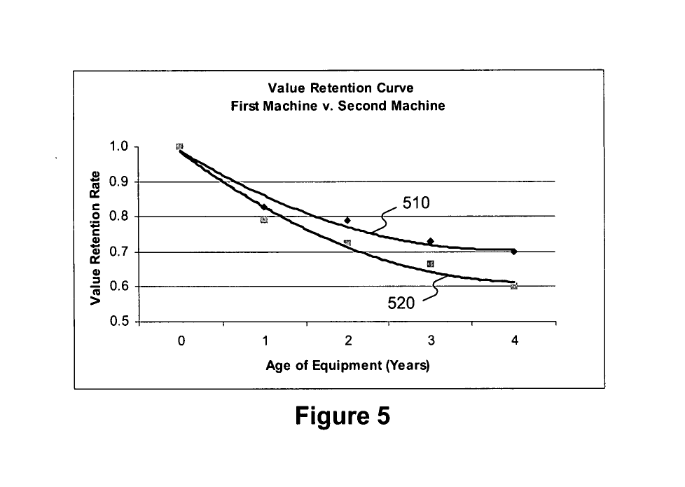

Further, used equipment management system 130 may fit value retention schedule 350 to a trend line using various statistical techniques such as linear regression (step 270). The trend line may be the best-fit line of the value retention rate schedule showing the value retention rate data as the dependent variable and equipment age as the independent variable. The trend line of a value retention schedule may be referred to as a value retention curve. FIG. 5 shows two exemplary value retention curves. Used equipment management system 130 may generate value retention curves 510 by fitting value retention schedule 350 to polynomial curves. Value retention curve 510 shows the estimated value retention rates for the first machine over five years of machine age. In another embodiment, used equipment management system 130 may fit a value retention schedule to an exponential curve, linear curve, etc.

Used equipment management system 130 may also generate a second value retention curve 520 for a second machine and compare the value retention schedules of the first and the second machine. In one embodiment, a user may receive and collect equipment sales data for the second machine. The user may use used equipment management system 130 to determine the median sales price for each machine age, determine the ratios of median sales prices of sequential equipment ages, determine the median ratio of median sales prices of sequential equipment ages across different time periods, and generate a value retention schedule for the second machine. As shown in FIG. 5, the user may then fit a polynomial curve to plot the second machine's value retention curve 520. The user may also use used equipment management system 130 to graph competing machine models (e.g., the first and second machines) or competing manufacturers on one chart. For example, FIG. 5 shows how the second machine depreciated over time (i.e., value retention curve 520) in comparison to the first machine (i.e., value retention curve 510).

Furthermore, a user may apply an appropriate transaction price for a new machine to a value retention curve to show the market value depreciation (or the relative transaction prices at various equipment ages) of a machine (step 280). The product of a transaction price and a value retention curve may be referred to as a value comparison curve. A value comparison curve for a machine may include a plot of relative transaction price data points for various equipment ages.

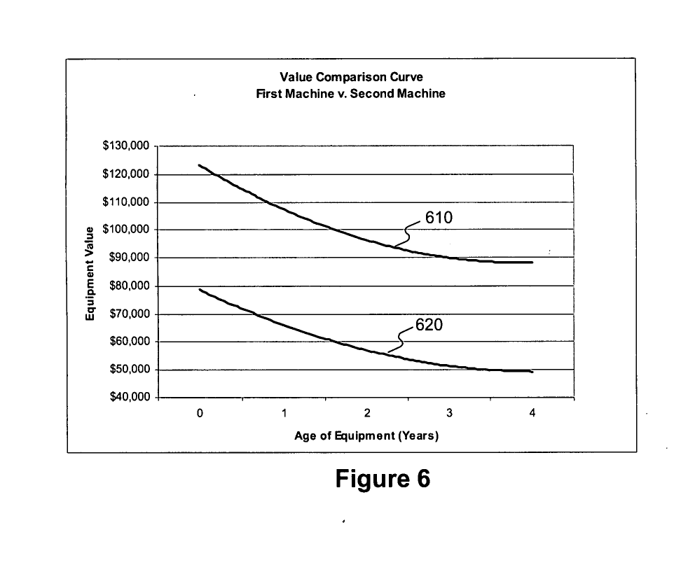

A user may further plot a value comparison curve of one or more machines using used equipment management system 130 (step 290). For example, FIG. 6 shows two exemplary value comparison curves for the first machine and the second machine in reference to the new transaction prices. Value comparison curve 610 of FIG. 6 corresponds to value retention curve 510 of FIG. 5. Value comparison curve 610 reflects the first machine's new transaction price of $125,000. Value comparison curve 610 shows the estimated, depreciated, market value of the first machine over a few years of machine age. Value comparison curve 620 of FIG. 6 corresponds to value retention curve 520 of FIG. 5. Value comparison curve 620 reflects the second machine's new transaction price of $80,000. Value comparison curve 620 shows the estimated market value depreciation of the second machine over a few years of machine life.

It should be noted that the disclosed embodiment may present value retention schedule information in any format, and the examples described above and shown in FIGS. 3 through 6 are not intended to be limiting. Any type of report (e.g., text, graphs, et.) may be generated to present a value retention schedule to a user or a software process.

### INDUSTRIAL APPLICABILITY

Methods and systems consistent with the disclosed embodiments enable the management of used equipment. In one embodiment, a management system may receive and store used equipment sales data. A user may request the management system to generate a value retention schedule. The management system may determine value retention rates and generate one or more value retention schedules for a given machine type. The value retention rates and value retention schedules may be used to determine the depreciation of the equipment. Such information is useful in, for example, tax documents and other financial processes, marketing, and other capital goods decisions. Additionally, the management system may use the value retention schedule to obtain a forward-looking view, which may be used for many types of business planning activities.

Methods and systems consistent with the disclosed embodiments may also enable a user or a business entity to evaluate and track market value retention rates of various machines. For example, a user may request value retention schedules for two types of equipment, such as two models of automobiles from two different manufacturers. The user may then compare the market value retention schedules of the two vehicles, and use the result of the comparison, to perform personal/business processes, such as deciding which vehicle to purchase, design changes of the vehicles, marketing strategy changes, etc. Similarly, a user may request value retention schedules for different types of equipment from multiple manufacturers, such as various models of automobiles from two competing manufacturers.

Methods and systems consistent with the disclosed embodiments may further be used as a business tool for industrial auctioneers and other equipment dealerships. For example, a dealer may use value retention schedules to help set sales price for used equipment. A used equipment dealer may also consider the value retention rates of used equipment when managing its inventory.

It will be apparent to those skilled in the art that various modifications and variations of the disclosed embodiments can be made. Additionally, other embodiments of the disclosed methods and systems will be apparent to those skilled in the art from consideration of the specification. It is intended that the specification and examples be considered as exemplary only, with a true scope of the disclosure being indicated by the following claims.

What is claimed is:

1. A method for generating a value retention schedule for used equipment using equipment transaction prices, the method including:
(i) receiving equipment sales records;
(ii) determining, based on the equipment sales records, a first median sales price of a first used equipment at a first equipment age for a set of time periods;
(iii) determining a second median sales price of the first used equipment at a second equipment age for the set of time periods;
(iv) determining a first ratio of the second median sales price to the first median sales price for each of the time periods in the set of time periods;
(v) determining a median ratio for the first ratio across the set of time periods;
(vi) determining a value retention rate for the second equipment age based on the determined median ratio; and
(vii) generating the value retention schedule based on the determined value retention rate.

2. The method of claim 1, wherein the second equipment age is a sequential age relative to the first equipment age.

3. The method of claim 2, further including:
assigning the first ratio to the second equipment age.

4. The method of claim 3, further including:
determining the value retention rate for the second equipment age by multiplying the determined ratio for the second equipment age and a value retention rate for the first equipment age.

5. The method of claim 2, further including:
receiving a request to generate the value retention schedule, the request identifying the piece of used equipment and the set of time periods.

6. The method of claim 5, wherein an equipment sales record reflects a sales price, a sales completion date, a used equipment model, and an equipment age.

7. The method of claim 2, further including:
generating a value retention curve by fitting the best functional form to the value retention schedule;
generating a value comparison curve by multiplying the value retention curve by an appropriate market transaction price; and
displaying the value retention schedule in a graphical format.

8. A system for generating a value retention schedule for used equipment, the system including:
a server; and
a memory storing data including equipment sales records, wherein the server is configured to:
(i) receive equipment sales records;
(ii) determine, based on the equipment sales records, a first median sales price of a first used equipment at a first equipment age for a set of time periods;
(iii) determine a second median sales price of the first used equipment at a second equipment age for the set of time periods;
(iv) determine a first ratio of the second median sales price to the first median sales price for each of the time periods in the set of time periods;
(v) determine a median ratio for the first ratio across the set of time periods;
(vi) determine a value retention rate for the second equipment age based on the determined median ratio; and
(vii) generate the value retention schedule based on the determined value retention rate.

9. The system of claim 8, wherein the second equipment age is a sequential age relative to the first equipment age.

10. The system of claim 9, the server is further configured to:
assign the first ratio to the second equipment age.

11. The system of claim 10, the server is further configured to:
determine the value retention rate for the second equipment age by multiplying the determined ratio for the second equipment age and a value retention rate for the first equipment age.

12. The system of claim 9, the server is further configured to:
receive a request to generate the value retention schedule, the request identifying the piece of used equipment and the set of time periods.

13. The system of claim 12, wherein an equipment sales record reflects a sales price, a sales completion date, a used equipment model, and an equipment age.

14. The system of claim 7, the server is further configured to:
generate a value retention curve by fitting the best functional form to the value retention schedule;
generate a value comparison curve by multiplying the value retention curve by an appropriate market transaction price; and
display the value retention schedule in a graphical format.

15. A computer-readable medium containing instructions to configure a processor to perform a method for generating a value retention schedule for used equipment, the method including:
(i) receiving equipment sales records;
(ii) determining, based on the equipment sales records, a first median sales price of a first used equipment at a first equipment age for a set of time periods;
(iii) determining a second median sales price of the first used equipment at a second equipment age for the set of time periods;
(iv) determining a first ratio of the second median sales price to the first median sales price for each of the time periods in the set of time periods;
(v) determining a median ratio for the first ratio across the set of time periods;
(vi) determining a value retention rate for the second equipment age based on the determined median ratio; and
(vii) generating the value retention schedule based on the determined value retention rate.

16. The computer-readable medium of claim 15, wherein the second equipment age is a sequential age relative to the first equipment age.

17. The computer-readable medium of claim 16, the method further including:
assigning the first ratio to the second equipment age; and
determining the value retention rate for the second equipment age by multiplying the determined ratio for the second equipment age and a value retention rate for the first equipment age.

18. The computer-readable medium of claim 16, the method further including:
receiving a request to generate the value retention schedule, the request identifying the piece of used equipment and the set of time periods.

19. The computer-readable medium of claim 16, the method further including:
receiving equipment sales data reflecting a sales price, a sales completion date, a used equipment model, and an equipment age.

20. The computer-readable medium of claim 16, the method further including:
generating a value retention curve by fitting the best functional form to the value retention schedule;
generating a value comparison curve by multiplying the value retention curve by an appropriate market transaction price; and
displaying the value retention schedule in a graphical format.
